(19) United States
(12) Patent Application Publication
(10) Pub. No.: US 2014/0016733 A1
(43) Pub. Date: Jan. 16, 2014

(54) PASSIVE SAFETY INJECTION SYSTEM USING SAFETY INJECTION TANK

(71) Applicant: KOREA ATOMIC ENERGY RESEARCH INSTITUTE, Daejeon (KR)

(72) Inventors: Young In KIM, Daejeon (KR); Joo Hyung MOON, Daejeon (KR); Soo Jai SHIN, Daejeon (KR); Jun LEE, Daejeon (KR); Keung Koo KIM, Daejeon (KR); Won Jae LEE, Gongju-si (KR); Suhn CHOI, Daejeon (KR); Tae Wan KIM, Daejeon (KR); Hark Rho KIM, Daejeon (KR); Cheon Tae PARK, Daejeon (KR); Seung Yeob YOO, Daejeon (KR); Young Min BAE, Daejeon (KR)

(21) Appl. No.: 13/938,568

(22) Filed: Jul. 10, 2013

(30) Foreign Application Priority Data
Jul. 12, 2012 (KR) 10-2012-0076241

(51) Int. Cl. G21C 15/18

(52) U.S. Cl. CPC G21C 15/18
USPC 376/282

(57) ABSTRACT

A passive safety injection system includes a containment, a reactor installed in the containment, safety injection tanks installed in the containment, a safety injection line between the reactor or a reactor coolant system and each of the safety injection tanks to guide water, which is stored in the safety injection tank, into the reactor when a water level in the reactor is reduced due to a loss of coolant accident, and a pressure balance line between the reactor or the reactor coolant system and the safety injection tank to guide high-temperature steam from the reactor into the safety injection tank upon the loss of coolant accident. The safety injection line has an orifice and a check valve thereon, and the pressure balance line has an orifice and isolation valves thereon. The water in the safety injection tank stably flows into the reactor for many hours.

### BACKGROUND OF THE INVENTION

1. Field of the Invention

The present invention relates generally to a passive safety injection system using a safety injection tank, and more particularly to a passive safety injection system using a safety injection tank, capable of safely supplying water, which is stored in a safety injection tank, to a reactor for many hours by independently or sequentially using differential head resulting from gas pressure and/or gravity instead of using a safety injection pump upon a loss of coolant accident.

2. Description of the Related Art

Different from a typical industrial power plant, a nuclear power plant generates residual heat from a reactor core for a considerable amount of time after a reactor has been shutdown, and an amount of the generated residual heat is rapidly reduced by lapse of time. Accordingly, the nuclear power plant has various safety facilities to ensure safety upon an accident.

Among several safety facilities, there are a safety injection system and a residual heat removal system as main systems to ensure the integrity of the core. The safety injection system complements a coolant when the coolant of the reactor is lost due to the loss of coolant accident such as the break of a line connected with the reactor, and the residual heat removal system removes sensible heat of the reactor and residual heat emitted from the core after the reactor core has been shutdown.

In other words, a passive reactor of a commercial reactor (loop type pressurized water reactor) includes a core makeup tank (high pressure safety injection), a pressurized-type safety injection tank (intermediate pressure safety injection), and an in-containment refueling water storage tank (low pressure safety injection). An active reactor of the commercial reactor includes a high pressure safety injection pump, a pressurized-type safety injection tank (intermediate pressure safety injection), and a low pressure safety injection pump (low pressure safety injection, integrated into high pressure safety injection lately).

The safety injection tank applied to the commercial reactor is a device to rapidly supply cooling water into the reactor by using the pressure of pressurized nitrogen in the safety injection tank when the internal pressure of the reactor is rapidly reduced due to the large break loss of coolant accident. In other words, the safety injection tank is designed to cope with the large break loss of coolant accident. The safety injection tank is a facility to ensure the margin of time until coolant is actually injected at a safety injection flow rate from a gravity-type passive safety injection system or a high pressure safety injection pump, and the safety injection tank is used for a short time (about 1 to 4 minutes after operating).

Accordingly, when the pressure of the reactor is rapidly reduced due to the large break loss of coolant accident in the active reactor, the safety injection system of the active reactor is operated in the sequence of “pressurized-type safety injection tank→high pressure safety injection pump”. When the pressure of the reactor is slowly reduced due to a small break loss of coolant accident in the active reactor, the safety injection system of the active reactor is operated in the sequence of “high pressure safety injection pump→pressurized-type safety injection tank”.

When the large break loss of coolant accident or the small break loss of coolant accident occur in the passive reactor, the passive safety injection system has the same operating sequence of “core makeup tank→pressurized-type safety injection tank→in-containment refueling water storage tank” in the two cases. However, since a gravity-type tank such as the core makeup tank represents a low gravitational head, an injection flow rate is low. Accordingly, in the initial stage of the large break loss of coolant accident, an injection flow rate of coolant injected from the pressurized-type safety injection tank occupies most parts of a safety injection flow rate of coolant injected into the core. In addition, an automatic depressurization system is operated in the passive reactor to reduce the pressure of the reactor so that the gravity-type safety injection such as the injection from the in-containment refueling water storage tank may be smoothly performed.

Meanwhile, in order to ensure a sufficient margin of time until the high pressure safety injection pump is operated, a fluidic device is provided in a pressurized-type safety injection tank installed in a part of commercial reactors of Korea for a 2-stage flow rate change using a swirling flow as shown in FIG. 7. According to the fluidic device applied to the part of the commercial reactors of Korea, the fluidic device equipped with a stand pipe and a vortex chamber is installed, and a weak flow resistance is represented before the stand pipe is exposed. After the stand pipe has been exposed, a phenomenon, in which the flow resistance of the fluidic device is increased by forming a strong swirling flow in the vortex chamber, is used and the pressure of nitrogen is continuously used till a time point at which the safety injection of the fluidic device is finished.

The main characteristics in cases that the fluidic device is installed in the above safety injection tank and not installed are shown in FIG. 8.

In addition, emergency core cooling schemes using a safeguard vessel, a pressurized-type safety injection tank, and a passive residual heat removal system in relation to an integral reactor are disclosed in Korean Patent Registration Nos. 10-419194, 10-856501, and 10-813939 issued on Feb. 5, 2004, Aug. 28, 2008, and Mar. 10, 2008, respectively. A reactor having a similar concept, in which a safeguard vessel is applied, has been developed (IRIS, Nuscale, U.S.).

However, since the safeguard vessel is a pressure vessel that is smaller than a containment building (a containment vessel or a reactor building) and larger than a reactor, the safeguard vessel has a great difficulty in solving problems related to the manufacturing and the transporting of the vessel, the long term of construction works, the integrity of a device installed in the safeguard vessel under a high temperature and high-pressure environment upon a loss of coolant accident, and the convenience in refueling and maintenance.

In a loop type passive reactor (AP1000 in the U.S.) according to the related art, a passive safety injection system is constructed by using a core makeup tank, a pressurized-type safety injection tank, an in-containment refueling water storage tank, and a re-circulating flow passage. The passive safety injection system is designed to supply a reactor with cooling water of a core makeup tank and a safety injection tank in the initial stage of the loss of coolant accident, and filling cooling water in the outside of the reactor after supplying coolant of an in-containment refueling water storage tank in the middle stage and the late stage of the accident to re-circulate the coolant. Among them, in the core makeup tank, a pressure balance line is connected with a high-temperature line, and an isolation valve is mounted on a safety injection line. The core makeup tank is designed to have the same pressure as that of the reactor. Accordingly, when the tank is manufactured in large size for the purpose of the usage for many hours, the manufacturing cost is greatly increased, and the pressure boundary of the reactor is expanded.

In addition, since the safety injection tank is similar to that applied to the loop type active reactor, the safety injection tank is insufficient for the purpose of the usage for many hours. In addition, different from the loop type reactor, since an integral reactor fundamentally eliminates a large break loss of coolant accident, the reactor is maintained under the higher pressure for many hours even if the loss of coolant accident occurs. Accordingly, the integral reactor has a difficulty in injecting external cooling water into the integral reactor by gravity without increasing the external pressure of the reactor (pressure balance) through a safeguard vessel.

In addition, the loop type active reactor according to the related art has employed a pressurized safety injection system and a safety injection pump to construct a safety injection system for the purpose of preparing for a large break loss of coolant accident. The pressurized-type safety injection tank rapidly supplies the reactor with the cooling water stored in the safety injection tank by using gas pressure for the period of core uncovery in the initial stage of the large break loss of coolant accident before suitable safety injection performance is achieved by operating the safety injection pump. In general, since the pressurized-type safety injection tank applied to the commercial reactor must be designed at higher pressure, the manufacturing cost of the pressurized-type safety injection tank is greatly increased, and the safety injection is finished early (in the range from several tens of seconds to several minutes), so that the pressurized-type safety injection tank is not suitable for the use of a safety injection system that must be operated for many hours.

### SUMMARY OF THE INVENTION

Accordingly, the present invention has been made keeping in mind the above problems occurring in the related art, and an object of the present invention is to provide a passive safety injection system using a safety injection tank, capable of supplying water stored in the safety injection tank into a reactor for many hours by mounting an orifice on a safety injection line connecting the safety injection tank with the reactor.

Another object of the present invention is to provide a passive safety injection system using a safety injection tank, in which the safety injection tank is connected with a reactor through a safety injection line and a pressure balance line to stably supply water stored in the safety injection tank into the reactor by independently or sequentially using differential head resulting from gas pressure and/or gravity.

To accomplish these objects, according to one aspect of the present invention, there is provided a passive safety injection system using a safety injection tank. The passive safety injection system includes a containment, a reactor installed in the containment, safety injection tanks installed in the containment and filled therein with water and nitrogen, a safety injection line having one end coupled with an upper portion of the reactor and an opposite end coupled with a lower portion of each of the safety injection tanks to guide the water, which is stored in the safety injection tank, into the reactor when a water level in the reactor is reduced due to a loss of coolant accident, and a pressure balances line having one end coupled with an upper portion of the reactor and an opposite end coupled with an upper portion of the safety injection tank to guide high-temperature steam generated from the reactor into the safety injection tank when the loss of coolant accident occurs. The safety injection line is mounted thereon with an orifice and a check valve, and the pressure balance line is mounted thereon with an orifice and isolation valves.

As described above, according to the passive safety injection system using the safety injection tank of the present invention, the water stored in the safety injection tank can flow into the reactor for many hours through the orifice mounted on the safety injection line.

In addition, according to the passive safety injection system using the safety injection tank of the present invention, the safety injection tank is connected with a reactor through the safety injection line and the pressure balance line to stably the supply water stored in the safety injection tank into the reactor based on differential head resulting from gravity.

In addition, according to the passive safety injection system using the safety injection tank of the present invention, the pressure balance line is inserted into the safety injection tank, and the perforating holes are formed at the inserted end portion of the pressure balance line, so that the safety depressurization function is partially performed, and the differential head resulting from gas pressure and/or gravity is sequentially used, thereby stably supplying water stored in the safety injection tank into the reactor, and simplifying facilities.

### BRIEF DESCRIPTION OF THE DRAWINGS

FIG. 1 is a view showing a passive safety injection system using a safety injection tank according to the present invention.

FIGS. 2 to 4 are views to briefly explain the water level of a safety injection tank in the passive safety injection system using the safety injection tank according to the present invention.

FIG. 5 shows graphs representing the variation in a safety injection flow rate and the water level of a reactor in the construction of the passive safety injection system to which the safety injection tank is applied according to the present invention.

FIG. 6 shows graphs representing the variation in a safety injection flow rate and the water level of a reactor in the construction of the passive safety injection system including a core makeup tank and a safety injection tank according to the present invention.

FIG. 7 is a view showing the shape of a fluidic device according to the related art.

FIG. 8 is a graph showing the variation in the flow rate characteristic of a safety injection tank according to the existence of a fluidic device.

### DETAILED DESCRIPTION OF THE INVENTION

The above and other objects, novel features and other advantages of the present invention will be more clearly understood from the following detailed description and accompanying drawings.

Hereinafter, the structure according to the present invention will be described with reference to accompanying drawings.

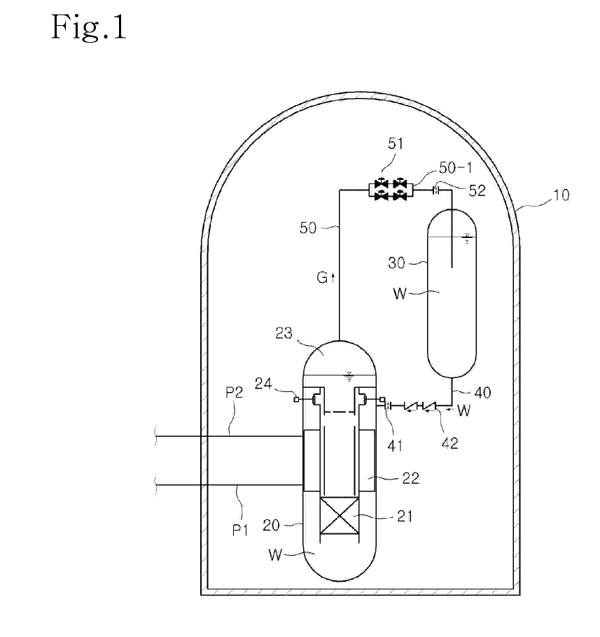

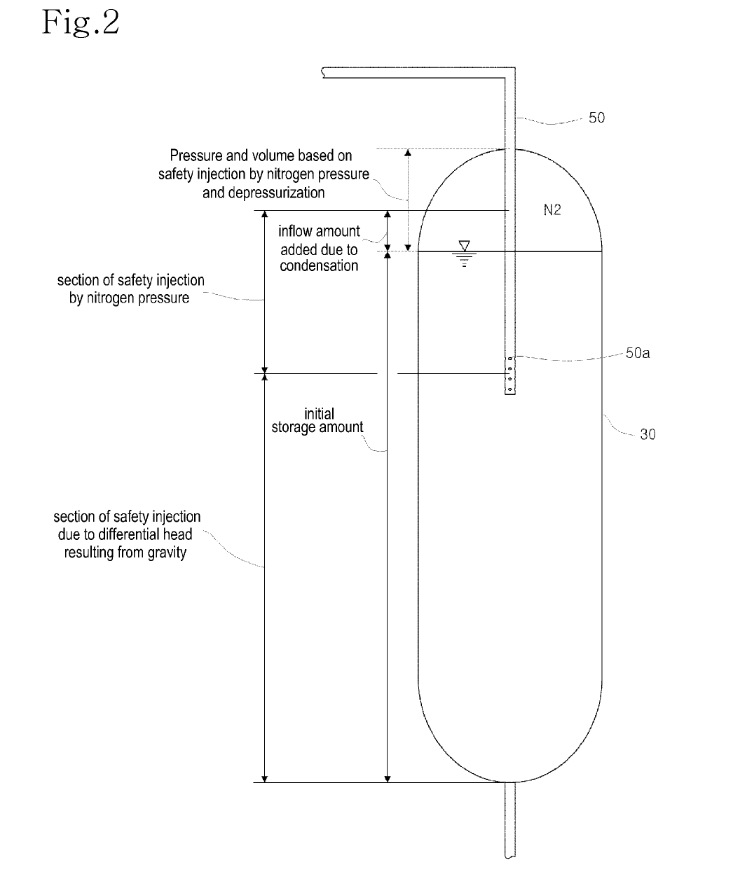

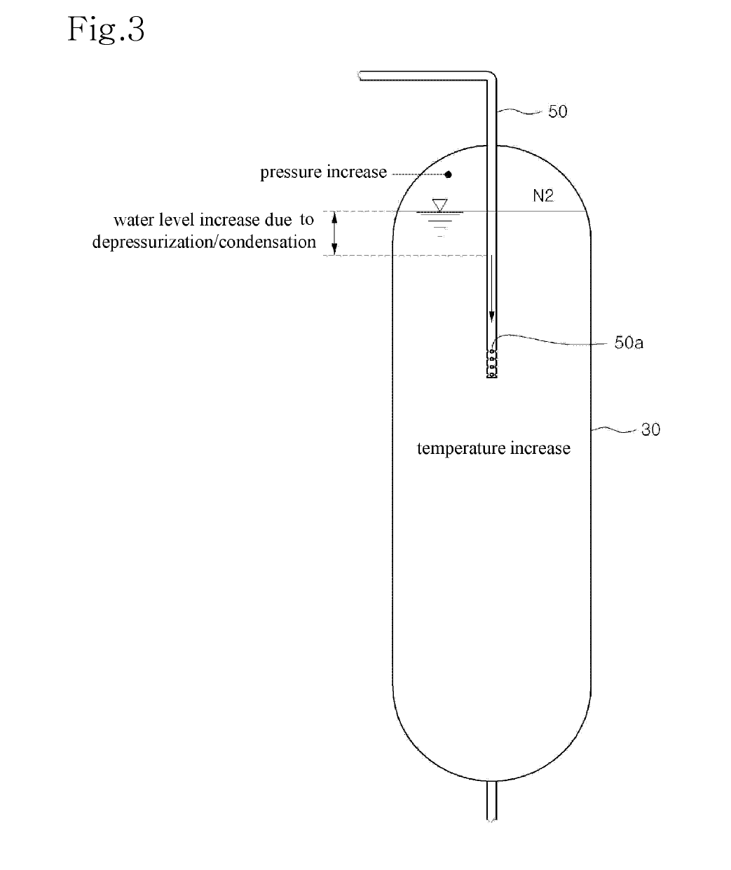

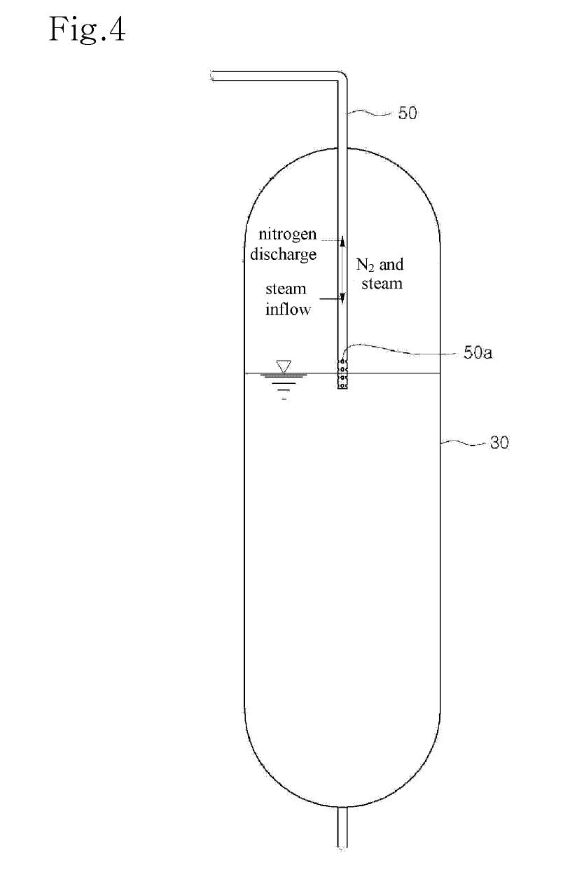

FIG. 1 is a view showing a passive safety injection system using a safety injection tank according to the present invention. FIGS. 2 to 4 are views to briefly explain the water level of a safety injection tank in the passive safety injection system using the safety injection tank according to the present invention.

The passive safety injection system using the safety injection tank according to the present invention includes a containment 10, which serves as a containment vessel or a reactor building or a safeguard vessel, a reactor 20 installed in the containment 10, a safety injection tank 30 installed in the containment 10, a safety injection line 40 to connect the reactor 20 with the safety injection tank 30, and a pressure balance line 50.

In the case of a loop type reactor, the reactor 20 corresponds to a reactor coolant system. In addition, the safety injection tank 30 may be installed outside the containment 10, or the pressure balance line 50 may not be installed according to the required characteristics of a nuclear power plant.

The containment 10 is a facility to prevent more than the regulatory limit of radioactive materials from being discharged into the environment beyond a controlled area upon a reactor accident.

The reactor 20 shown in FIG. 1 includes main devices, such as a core 21, steam generators 22, a pressurizer 23, and impellers of reactor coolant pumps 24, installed in a reactor vessel. The reactor vessel reserves a great amount of cooling water W therein. A feed water line P1 and a steam line P2 are connected with the steam generator 22 of the reactor 20, and various kinds of small lines are connected with the reactor 20 for the operation of the reactor 20.

The safety injection tank 30 is connected with the reactor 20 by both of the safety injection line 40 and the pressure balance line 50. The safety injection tank 30 not only stores water W therein, but also is filled therein with gas to pressurize the water W. The gas filled in the safety injection tank 30 generally is nitrogen.

The safety injection line 40 has one end coupled with an upper portion of the reactor 20 and an opposite end coupled with a lower end of the safety injection tank 30. The water level in the reactor 20 is lowered if the loss of coolant accident occurs due to the accident such as line break. Since the amount of cooling water is insufficient to drop the temperature of the core 21 of the reactor 20, if the water level in the reactor 20 is lowered, the water stored in the safety injection tank 30 is supplied into the reactor 20 in order to overcome the lack of the cooling water. In other words, the water stored in the safety injection tank 30 flows into the reactor 20 through the safety injection line 40.

The above safety injection line 40 is mounted thereon with an orifice 41. The orifice 41 greatly increases the flow resistance of the safety injection line 40 so that the water W stored in the safety injection tank 30 may slowly flow into the reactor 20 for many hours.

In addition, the safety injection line 40 is mounted thereon with check valves 42. The check valves 42 are mounted as described above to prevent the water W from flowing back from the reactor 20 to the safety injection tank 30 under the high-pressure condition that the reactor 20 is normally operated.

The pressure balance line 50 connects the reactor 20 with the safety injection tank 30, and has one end coupled with an upper end or the upper portion of the reactor 20 and an opposite end coupled with an upper portion of the safety injection tank 30. Accordingly, if the loss of coolant accident occurs, high-temperature steam G generated from the reactor 20 flows along the pressure balance line 50 so that the high-temperature steam G is supplied into the safety injection tank 30.

In the case of the loop type reactor, a pressure balance line and a safety injection line are connected with the reactor coolant system.

The pressure balance line 50 is mounted thereon with isolation valves 51 so that the isolation valves 51 are automatically open if the pressure of the reactor 20 is reduced to a set value or less for the operation of the isolation valve 51 upon the loss of coolant accident. If the closed isolation valves 51 are open, the high-temperature steam G generated from the reactor 20 is supplied into the safety injection tank 30. The isolation valves 51 may be mounted on two branch lines 50-1 connected with the pressure balance line 50 in such a manner that the isolation valves 51 may be independently operated by two. Accordingly, the single failure of isolation valves can be taken into consideration, and the closing and the opening of the isolation valves 51 can be ensured.

The total four isolation valves 51 mounted on the pressure balance line 50 backups power from a battery in preparation for power loss so that the pressure balance line 50 may be open or closed. In detail, the isolation valve 51 usually receives power through an ordinary power line, and opens/closes the pressure balance line 50 by backup power in the case of emergency.

Accordingly, if the loss of coolant accident occurs, the isolation valves 51 are open according to an operating signal, and the high-temperature steam G generated from the reactor 20 flows along the pressure balance line 50 so that the high-temperature steam G is supplied into the safety injection tank 30.

In addition, the pressure balance line 50 may be mounted thereon with an orifice 52. In more detail, the orifice 52 may be mounted on the pressure balance line 50 interposed between the isolation valves 51 and the safety injection tank 30. The orifice 52 is mounted on the pressure balance line 50 to relieve the excessive pressure fluctuation when the high-temperature steam G flows from the reactor 20 and to accommodate the variation of the flow resistance of a line depending on the arrangement of the line and valves, so that the line can be easily designed.

Meanwhile, the opposite end of the pressure balance line 50 is inserted into the safety injection tank 30, and provided in the inserted part thereof with a plurality of perforating holes 50a. In more detail, the opposite end of the pressure balance line 50 is submerged into the water stored in the safety injection tank 30.

The opposite end of the pressure balance line 50, which is provided therein with the perforating holes 50a and submerged in the water stored in the safety injection tank 30, is exposed to a nitrogen atmosphere inside the safety injection tank 30 if the water level of the safety injection tank 30 is lowered, so that nitrogen filled in the safety injection tank 30 is mutually exchanged with the high-temperature steam G supplied into the safety injection tank 30 from the reactor 20.

Regarding the flow of gas and steam in the pressure balance line 50, an inner part of the reactor 20 is set to high pressure, and an inner part of the safety injection tank 30 is set to low and medium pressure lower than the normal operation pressure of the reactor 20. If the loss of coolant accident such as line break occurs in this state, the internal pressure of the reactor 20 is reduced. If the pressure of the reactor 20 is reduced to the set value or less for the operation of the isolation valves 51 thereafter, the isolation valves 51 mounted on the pressure balance line 50 are open, so that the high-temperature steam G generated from the inner part of the reactor 20 is supplied into the safety injection tank 30 and condensed. Accordingly, if the isolation valves 51 are open in the initial stage of the loss of coolant accident, the level of the water W stored in the safety injection tank 30 is raised.

Next, if the pressure of the reactor 20 is reduced due to the continuous discharge of the steam G from the reactor 20 and the cooling by the passive residual heat removal system, and if the internal pressure of the safety injection tank 30 is increased more than the internal pressure of the reactor 20 due to the continuous supply of the steam G from the reactor 20 and the continuous pressure decrease of the reactor 20, the water W stored in the safety injection tank 30 is supplied into the reactor 20 through the safety injection line 40 by the pressure of the nitrogen filled in the safety injection tank 30.

In the state that the isolation valves 51 are open and the internal pressure of the reactor 20 is higher than the pressure of the safety injection tank 30, the safety injection tank 30 serves as a depressurization tank to receive the steam G discharged from the reactor 20, and the isolation valves 51 serve as safety depressurization valves. Thereafter, if the level of the water W stored in the safety injection tank 30 is reduced to reach the opposite end of the pressure balance line 50 inserted into the safety injection tank 30, a passage of steam G and nitrogen are formed between the reactor 20 and the safety injection tank 30, so that the steam G and the nitrogen may be exchanged through the passage. If the steam G and the nitrogen are exchanged, so that the internal pressure of the safety injection tank 30 is balanced with the internal pressure of the reactor 20, the water W stored in the safety injection tank 30 is continuously supplied into the reactor 20 due to the difference between the level of the water stored in the safety injection tank 30 and the level of the water stored in the reactor 20, that is, a gravity differential head. Since the water level of the safety injection tank 30 is higher than that in the reactor 20, water flows from the safety injection tank 30 to the reactor 20 by gravity.

In more detail, when the opposite end of the pressure balance line 50 having the perforating holes 50a is submerged in the water W stored in the safety injection tank 30, the high-temperature steam G supplied from the reactor 20 is condensed in the safety injection tank 30, so that the level of the water W stored in the safety injection tank 30 is raised while the temperature of the water W is being increased, and the internal nitrogen pressure of the safety injection tank 30 is increased.

Thereafter, as the water W stored in the safety injection tank 30 is continuously supplied into the reactor 20, the opposite end of the pressure balance line 50 having the perforating holes 50a submerged into the water W is exposed, the high-temperature steam G supplied from the reactor 20 through the perforating holes 50a is exchanged with the nitrogen in the safety injection tank 30 so that the reactor 20 and the safety injection tank 30 make pressure balance together.

If the reactor 20 and the safety injection tank 30 make pressure balance together, the water W stored in the safety injection tank 30 is supplied into the reactor 20 due to the differential head of the safety injection tank and the reactor 20 instead of the pressure of the nitrogen.

In other words, since the safety injection tank 30 is placed higher than the reactor 20, the level of the water W stored in the safety injection tank 30 becomes higher than the level of the cooling water W stored in the reactor 20. Accordingly, the water W stored in the safety injection tank 30 is supplied into the reactor 20 due to the difference in the water level between the safety injection tank 30 and the reactor 20.

As described above, the present invention relates to a safety injection system to be installed in a reactor which fundamentally eliminates the large break loss of coolant accident like an integral reactor. More particularly, the present invention relates to a passive safety injection system to perform safety injection by using natural force such as gas pressure or gravity existing in the system instead of a pump such as a safety injection pump for a considerable amount of time until residual heat is significantly reduced after an accident has occurred, and relates to a passive safety injection system to operate at the middle and late stages of the accident and perform safety injection for many hours. The passive safety system is designed to safely maintain the reactor for many hours (present requirement, 72 hours or more) without an action taken by an operator even if an external AC power system including an emergency diesel generator provided in the nuclear power plant cannot be used upon a design basis accident.

When comparing with the loop type reactor in which the large break loss of coolant accident may occur, the large break loss of coolant accident cannot occur in the integral reactor. Accordingly, if the loss of coolant accident occurs in the integral reactor, the pressure of the reactor is slowly reduced.

Based on the above characteristics, the present invention is constructed by improving a pressurized-type safety injection tank applied to a commercial reactor according to the related art based on a required characteristic (72-hour operation) of the integral reactor for safety injection.

The present invention is constructed in a pressurized type, a gravity type, and a mixed type thereof, and constructed in such a manner that one type safety injection tank has high flow rate (safety injection tank, pressurized-type) and low flow rate (safety injection, gravity-type) characteristics by improving a high flow rate-medium flow rate-low flow rate safety injection system according to the related art. Alternatively, the present invention is constructed in such a manner that a core makeup tank (high flow rate, gravity type) is additionally applied and a safety injection tank has medium flow rate (safety injection tank, pressurized-type) and low flow rate (safety injection tank, gravity-type) characteristics.

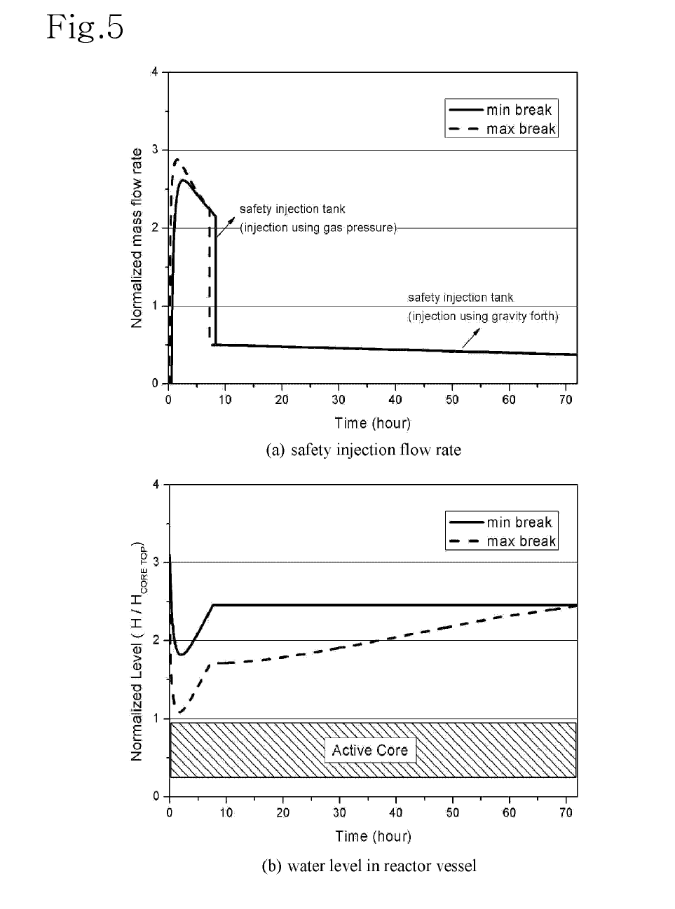

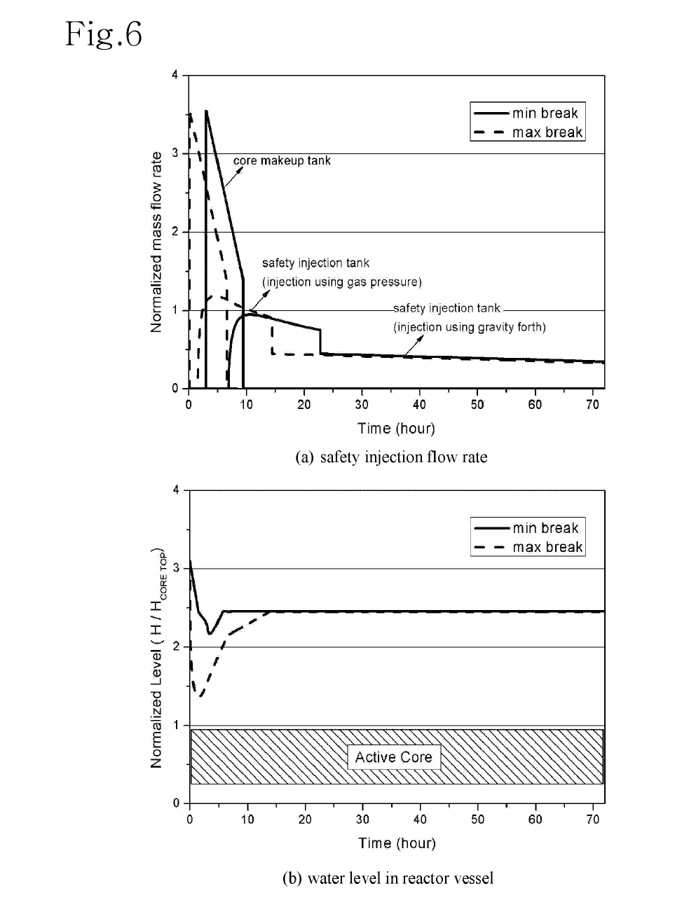

When one type safety injection tank has high flow rate (safety injection tank, pressurized-type) and low flow rate (safety injection, gravity-type) characteristics, the safety injection flow rate and the variation in the water level of the reactor are shown in FIG. 5. When the core makeup tank (high flow rate, gravity-type) is additionally applied and the safety injection tank has a medium flow rate (safety injection tank, pressurized-type) and low flow rate (safety injection tank, gravity-type) characteristics, the safety injection flow rate and the variation in the water level of the reactor are shown in FIG. 6.

FIG. 5 shows graphs representing the variation in a safety injection flow rate and the water level of a reactor in the construction of the passive safety injection system to which the safety injection tank is applied according to the present invention. FIG. 6 shows graphs representing the variation in a safety injection flow rate and the water level of a reactor in the construction of the passive safety injection system including a core makeup tank and a safety injection tank according to the present invention.

As shown in FIGS. 5 and 6, if the safety injection tank according to the present invention is applied, when the loss of coolant accident occurs, a core is not exposed, and safety injection is suitably performed. However, FIGS. 5 and 6 show one of detailed embodiments according to the present invention. The safety injection performance may be improved or degraded according to design application of the present invention, such as the design pressure, the operating pressure, the gas pressure, the fluid volume, the tank diameter, the tank height, the tank capacity, and the depth of an insertion tube of the safety injection tank.

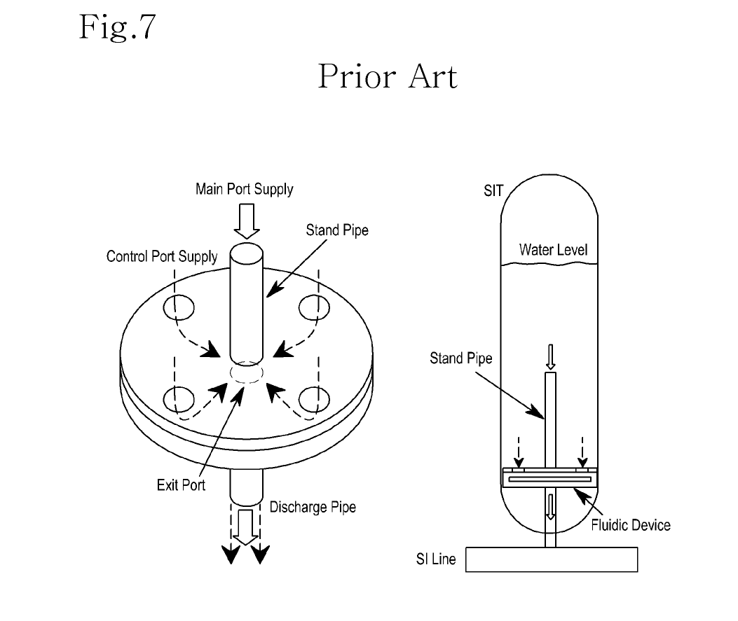

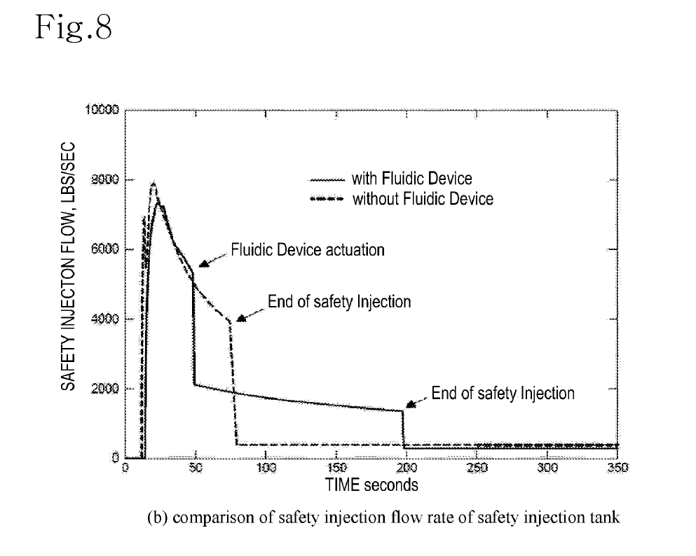

In addition, a fluidic device according to the related art is mounted on a lower portion of a pressurized-type safety injection tank, uses a swirling phenomenon, and uses nitrogen pressure till a time point at which the safety injection is finished as shown in FIG. 7. However, the present invention makes a difference from the related art in that the safety injection tank according to the present invention serves as a depressurization tank, an insertion tube is installed in an upper portion of the safety injection tank, the safety injection tank uses a phenomenon, in which an injection flow rate is changed when the type of the safety injection tank is changed to a pressure balance-type (gravity-type) similar to that of a core makeup tank, at a time point in which pressurized-type safety injection is finished instead of a swirling flow.

In detail, in terms of the flow rate change except for the function of the depressurization tank, the object of the fluidic device according to the related art is similar to the object of the present invention. However, the related art and the present invention basically make the following difference. Although the fluidic device according to the related art uses a phenomenon in which a flow resistance is increased due to a swirling flow at a time point in which a flow rate is changed so that the flow rate is reduced, the present invention uses a phenomenon, in which driving force for safety injection is changed from gas pressure to gravity so that the flow rate is reduced, instead of the phenomenon of increasing the flow resistance.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A passive safety injection system using a safety injection tank, the passive safety injection system comprising:
a containment;
a reactor installed in the containment;
safety injection tanks installed in the containment and filled therein with water and nitrogen; and
a safety injection line having one end coupled with an upper portion of the reactor or a reactor coolant system and an opposite end coupled with a lower portion of each of the safety injection tanks to guide the water, which is stored in the safety injection tank, into the reactor when a water level in the reactor is reduced due to a loss of coolant accident,
wherein an orifice is mounted on the safety injection line.

2. The passive safety injection system of claim 1, further comprising a check valve mounted on the safety injection line interposed between the reactor or the reactor coolant system and the safety injection tank.

3. The passive safety injection system of claim 1, wherein the reactor or the reactor coolant system is connected with the safety injection tank through a pressure balance line mounted thereon with isolation valves, and
wherein the pressure balance line has one end coupled with an upper portion of the reactor or the reactor coolant system and an opposite end coupled with an upper portion of the safety injection tank, and the isolation valves are open when the loss of coolant accident occurs, such that high-temperature steam generated from the reactor is supplied into the safety injection tank.

4. The passive safety injection system of claim 3, wherein the isolation valves are mounted on two branch lines connected with the pressure balance line such that the isolation valves are independently operated by two.

5. The passive safety injection system of claim 3, wherein the isolation valves receive power from a battery such that the pressure balance line is open or closed.

6. The passive safety injection system of claim 3, further comprising an orifice mounted on the pressure balance line interposed between the reactor or the reactor coolant system and the safety injection tank.

7. The passive safety injection system of claim 3, wherein the opposite end of the pressure balance line is inserted into the safety injection tank, and provided in the inserted part thereof with a plurality of perforating holes.
